(19) United States
(12) Patent Application Publication
(10) Pub. No.: US 2008/0247839 A1
(43) Pub. Date: Oct. 9, 2008

(54) Tensionable Cable Bolt Apparatus and System

(76) Inventor: Ben L. Seegmiller, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/697,511

(22) Filed: Apr. 6, 2007

(51) Int. Cl. F16B 13/06

(52) U.S. Cl. 411/44

(57) ABSTRACT

A cable thread insert, the insert integrated into a multiwire cable to provide a threaded portion of the cable. The threaded cable is capable of being used as part of a tensionable cable bolt apparatus and system.

### CROSS REFERENCE TO RELATED APPLICATIONS

No claim is made to any pending application.

### BACKGROUND

Rigid members such as steel rods or rebar have long been used in anchoring systems in construction applications and as rock bolts in mining applications. For example, threaded rebar manufactured and sold by DYWIDAG under the brand name Threadbar has been used for rock bolts for years. Anchoring such rods or rebar at one end or at both ends allows the rod to bear a tension load. Steel rods have been particularly useful in anchoring applications because threads can be formed on the outer surface of the rods to receive desired bolts with corresponding threads or to receive other fastening devices such as a Frazer-Jones D9 expansion shell assembly. Rigid steel rods are, however, not always ideal because they are manufactured in finite, fixed lengths and long rods are often difficult to work with in confined spaces such as construction and mining sites. Rigid rods can also be subject to shearing stresses if, for example, there is ground movement adjacent the rod in a mining application.

Steel cables comprising multiple strands of steel have also been used as anchoring systems. Unlike rigid, steel rods, cables provide some flexibility along their length. That is, a cable can bent around an object or deflect when subject to ground movement adjacent the cable. In some instances, steel cable is easier to use in confined spaces. Historically, anchoring a cable at one or both ends is more difficult because the cable does not bear threads to receive bolts. A number of cable anchoring methods have been used. One example is a multistrand anchorage device which separates strands of the cable and anchors each strand individually or in groups such as the DYWIDAG Multistrand Posttensioning System. Another example comprises fixing a thread-bearing sleeve over the cable at the desired locations to receive a desired bolt or Jones-Frazer D9 expansion shell assembly.

Another example includes unraveling the cable and sliding a ring over and down along the center or king wire of the cable to a desired location and then rewinding the cable. In this way, a bulge or ‘bird cage’ is formed in the cable due to a spreading of the wires in the area of the ring. The bulge or spreading of the wires permits resin used with the cable to permeate into the cable to enhance anchorage of the cable upon the setting of the resin. If mechanical anchorage is also desired, an additional thread-bearing or thread-like-bearing apparatus must still be added if a desired bolt or Jones-Frazer D9 expansion shell assembly is to be used. What is needed is a device to convert standard cable into a thread-bearing or thread-like cable to receive a desired bolt or fastening device such as a Frazer-Jones D9 expansion shell assembly without relying upon a thread-bearing sleeve being disposed about the cable.

### SUMMARY

An exemplary embodiment of the present invention is a tensionable cable bolt system comprising a cable, a mechanical retaining piece, a cable thread insert and an expansion shell assembly. A novel feature of the present invention is the cable thread insert. The cable thread insert has a length and comprises a center hole to receive the king wire. The cable thread insert is disposed over the center or king wire of the cable when the wire is temporarily unraveled. The cable thread insert further comprises a plurality of wire receiving grooves along its length to receive the other wires of the cable. The cable thread insert comprises a threaded portion between the receiving grooves such that the threaded portion is disposed between the plurality of wires about the perimeter of the cable so that the threads extends beyond the perimeter surface of the cable. The cable is then retwisted and holds the cable thread insert in the desired location. The threaded portion of the cable thread insert is then available to engage a desired bolt or other fastening device such as a Frazer-Jones D9 expansion shell assembly.

In a mining application, a hole is drilled into the subject rock. Unset, separated resin components are disposed in the hole at the desired locations along the length of the hole. The system of the present invention is inserted into the hole. A commonly known mechanical device spins the system inside the hole. The spinning action causes two events. The separated resin components are mixed so that the resin can begin to set. In addition, as the cable is spun, the cable thread insert engages the expansion shell assembly causing the shell assembly to expand radially to mechanically anchor against the inside wall of the hole.

### BRIEF DESCRIPTION OF THE DRAWINGS

FIG. 1 illustrates a standard cable with a center or king wire and strands wrapped around the king wire.

FIG. 2 illustrates a button clamped to the cable and a washer or retaining device resting next to the button.

FIG. 3 illustrates an exemplary embodiment of the new cable thread insert.

FIG. 4 illustrates an exemplary embodiment of the new cable thread insert integrated into a cable.

FIG. 5 illustrates an exemplary embodiment of a standard leaf type expansion member.

FIG. 6 illustrates an exemplary embodiment of a standard cable bearing a button, retaining piece with an integrated cable thread insert and a lead type expansion member disposed about the cable adjacent the retaining piece.

FIG. 7 illustrates an exemplary embodiment of an expansion wedge with a guide fin lying along the wedge's major axis.

FIG. 8 illustrates an exemplary embodiment of the components of the tensionable cable bolt system in its unexpanded state.

FIG. 9 illustrates an exemplary embodiment of the components of the tensionable (cable bolt system in its expanded state.

FIG. 10 illustrates one mining application of the components of the tensionable cable bolt system wherein the system is partially encapsulated in resin.

FIG. 11 illustrates another mining application of the components of the tensionable cable bolt system wherein the system is fully encapsulated in resin.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein. Moreover, the Figures may show simplified or partial views, and the dimensions of elements in the Figures may be exaggerated or otherwise not in proportion for clarity. In addition, as the terms “on” and “attached to” are used herein, one object (e.g., a material, a layer, a substrate, etc.) can be “on” or “attached to” another object regardless of whether the one object is directly on or attached to the other object or there are one or more intervening objects between the one object and the other object. Also, directions (e.g., above, below, top, bottom, side, “x,” “y,” “z,” etc.), if provided, are relative and provided solely by way of example and for ease of illustration and discussion and not by way of limitation.

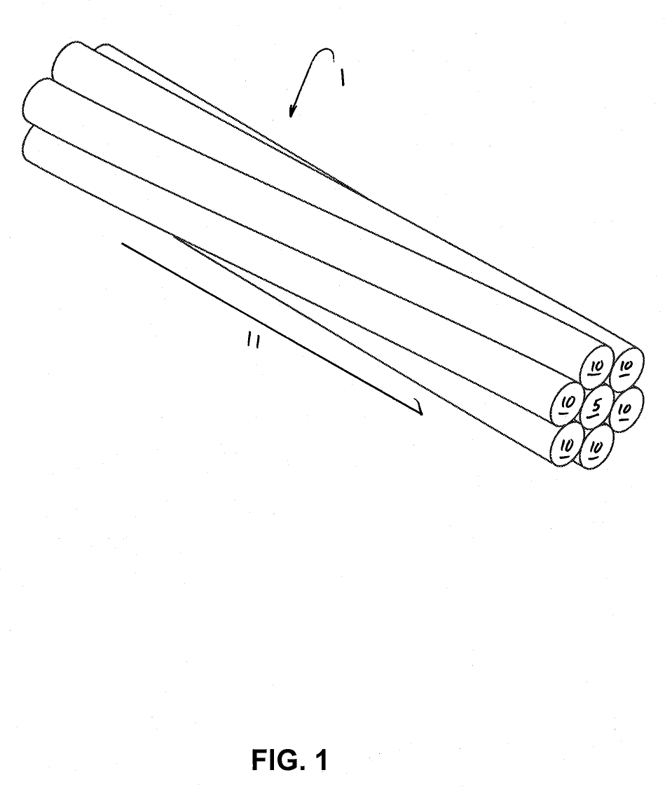

FIG. 1 illustrates a cable 1 having a center or king wire 5 and a plurality of strands 10 helically wrapped around king wire 5. Cable 1 may very in size, but the size commonly used for anchoring heavy loads in construction projects and mining are 0.6 and 0.7 inch outside diameter cable. The exemplary configuration illustrated here is typical of cables used by a person of ordinary skill in the art. It is well known in the art that such cable can be unraveled by applying a twisting force counter to the helical wrap. In doing so, the wires comprising the cable spread out so there is some space between each wire or strand. The primary axis 11 of the cable 1 runs the length of the cable and in the direction of the tension load.

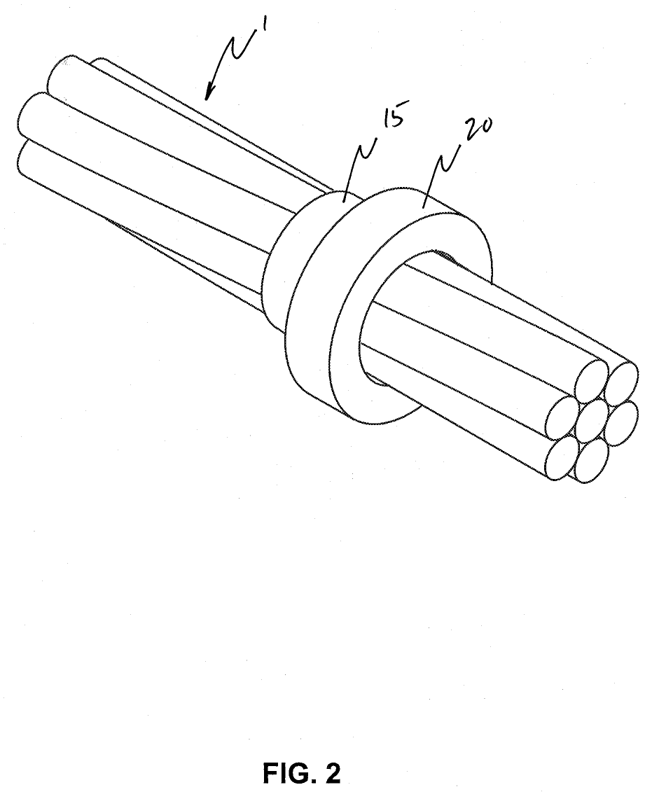

FIG. 2 illustrates an exemplary embodiment of a cable 1 having a button 15 or other mechanically crimped member placed or clamped around the circumference of cable 1 at a desired location to provide a stop against which other components such as washer or retaining piece 20 are prevented from moving beyond the button 15. In an exemplary embodiment retaining piece 20 may move freely along the primary axis 11 of the cable 1, but it cannot go beyond button 15. In alternative exemplary embodiments, a birdcage (not shown) is created by unraveling the cable and inserting a small annular member about king wire 5 at a desired location. The remaining strands of the cable are rewrapped around the king wire. Due to the presence of the small annular member about king wire 5, the strands wrapped around the small annual member causing a bulge or ‘birdcage’ in the cable. This combination increases the circumference of the cable combination and prevents washer 20 from passing beyond the birdcage.

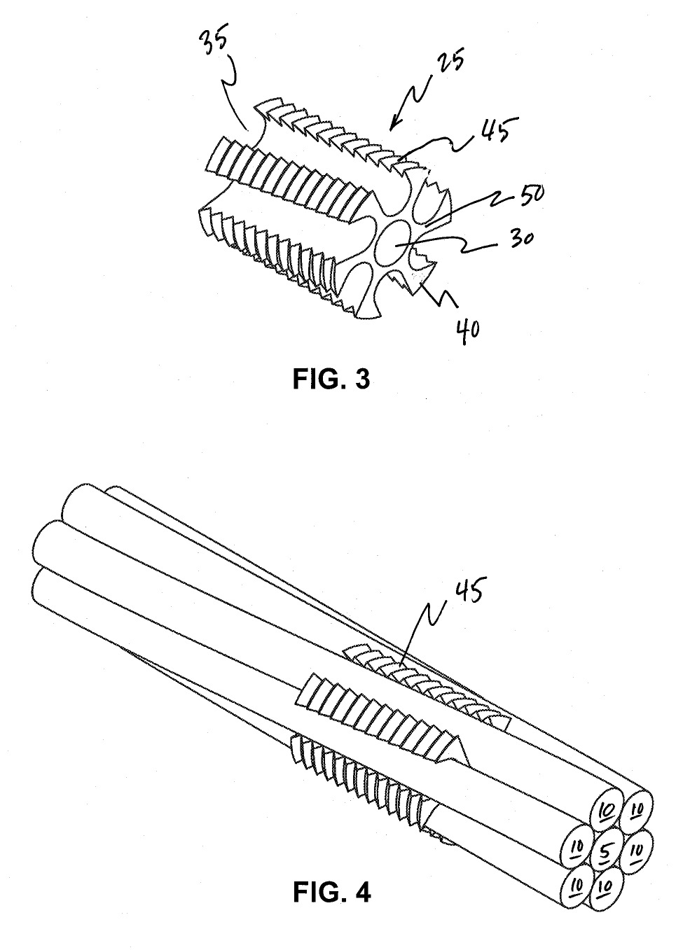

FIG. 3 illustrates an exemplary embodiment of the new cable thread insert. The cable thread insert 25 may be constructed of B7 Carbon Steel or other suitable material and may be manufactured by machining, casting, molding, extrusion or any other suitable manufacturing methods known to one of ordinary skill in the art. When extruded, cast or molded, the cable thread insert may be manufactured in extended lengths and cut to desired lengths. The length of cable thread insert 25 may be varied between ⅛ of an inch up to any desired length depending on the amount of revolutions of spin needed to place the system or the amount of tension needed, all known to one of skill in the art.

As illustrated in FIG. 3, cable thread insert 25 has a hollow channel or lumen 30 through which king wire 5 can pass. Channel 30 may be sized to match the diameter of the king wire 5 to minimize the play of cable thread insert, and to increase structural support for the walls of the hollow channel as strands 10 exert a compression force on cable thread insert 25 when it is integrated into cable 1.

An exemplary embodiment of cable thread insert 25 further comprises flanges 40 extending generally radially outward from channel 30. Flanges 40 comprise a width 50 sufficient to bear the sheer stress placed thereon when integrated into a cable. A person of ordinary skill in the art can identify width 50 without undue experimentation. Flanges 40 are helically disposed along the length of cable thread insert 25. The sidewalls of flanges 40 create wire or strand receiving grooves 35 also helically about cable thread insert 25. The helical angle of grooves 35 can vary as needed to be compatible with the chosen cable. That is, the helical angle is selected to correspond with the helical arrangement of the wires or strands 10 about king wire 5. Groove 35 is preferably shaped to comprise a curved trough near channel 30 to seat stand 10 placed therein when cable thread insert 25 is integrated into cable 1.

Cable 1 is unwound to create sufficient space between the wires of cable 1. Cable thread insert 25 is disposed about king wire 5 at the desired location and strands 10 are inserted into cable receiving grooves 35. Strands 10 are rewrapped around king wire 5 thereby securing flanges 40 between strands 10.

As illustrated in FIGS. 3, 4, 6, 8 and 10, flanges 40 comprise a threaded portion 45. Threaded portion 45 extends sufficiently beyond the perimeter of cable 1 to provide threads extending outwardly from cable 1. Threads 45 provide a typical screwing mechanism.

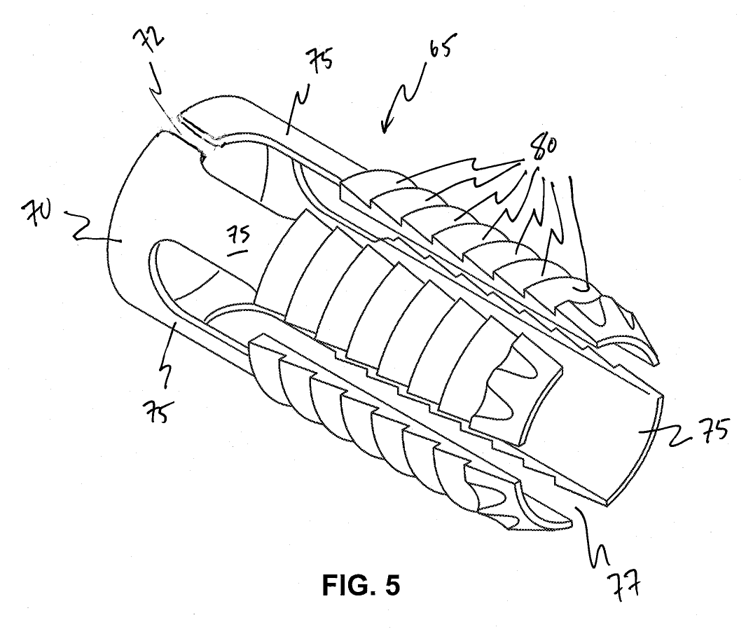

FIG. 4 illustrates an exemplary embodiment of cable thread insert 25 integrated into a cable 1. As shown, once integrated, cable thread insert 25 is partially concealed between the strands 10 and the king wire 5, with the strands 10 seating within the grooves 35. As a result, the threads 45 of the outer edge of the flanges 40 are exposed, thus enabling threaded portion 45 to receive and mechanically couple to a desired bolt or other fastening device. While the present invention illustrates threaded portions 45 of cable thread insert 25 exposed between each wire 10, the present invention contemplates that a threaded portion 45 need not be present between each wire 10, but only need be present between a sufficient number of wires 10 to provided the needed threads to act upon the corresponding threads of wedge 85 discussed below.

FIG. 5 illustrates an exemplary embodiment of a customary expandable leaf type shell 65 commonly known in the art. Such devices are sold as the Frazer-Jones D9 expandable shell assembly. The base 70 of the leaf type member 65 forms a expandable band with a cut out nook 72 to allow the base to expand. A plurality of leaves 75 extend from the base 70 and are flexible so as to expand away from primary axis of the leaf type member 65 when a force is exerted away from the center. Leaves 75 define spaces 77 between leaves 75. On the outer surface of the leaves are ridges 80.

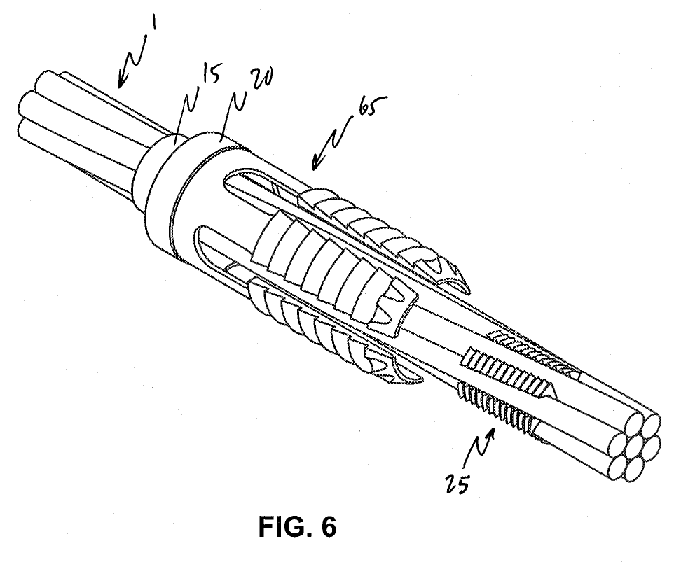

FIG. 6 illustrates an exemplary embodiment of an integrated cable-cable thread insert 60 with a button 15 clamped to cable 1 and with washer 20 stopped by button 15. Leaf assembly 65 is shown disposed about cable 1 and resting against washer 20. As illustrated, leaf type member 65 and washer 20 are not fixed in position relative to cable 1, are able to spin around cable 1 and can slide up and down the length of the cable 1 without passing over button 15.

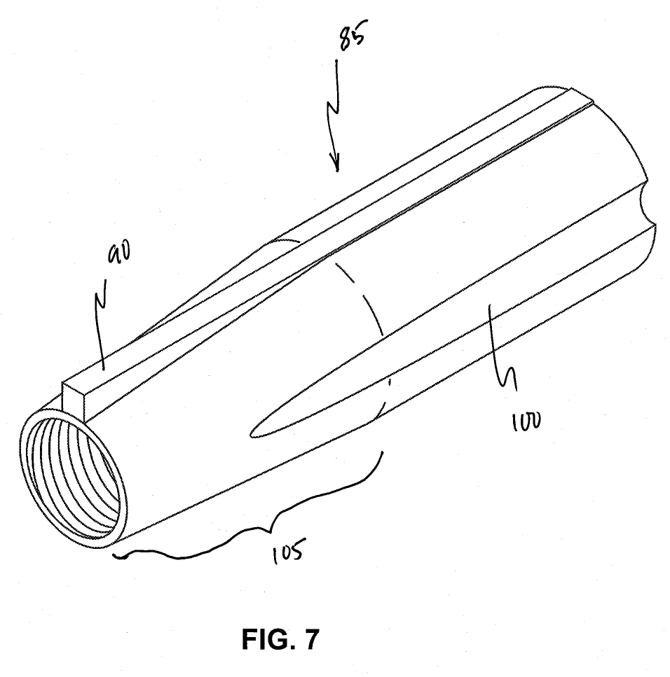

As illustrated in FIG. 7, the expandable shell assembly further comprises an expansion wedge 85. Wedge 85 can be a standard wedge provided as part of a Frazer-Jones D9 expandable shell assembly. Wedge 85 may be modified to comprise a guide fin 90 lying along the wedge's major axis. Fin 90 is disposed in space 77 of leaf assembly 65. The external surface 105 of wedge 85 may be tapered as desired. The angle of the taper can be varied and selected to achieve the desired amount and rate at which leaves 75 expand and contact the adjacent structure in which the assembly is being anchored. The internal surface of wedge 85 is threaded so as to selectively couple with threaded portion 45 of cable thread insert 25. A plurality of grooves 100 may be formed on the exterior surface of wedge 85 to provide for the passage or flow of resin around or past wedge 85, as discussed below.

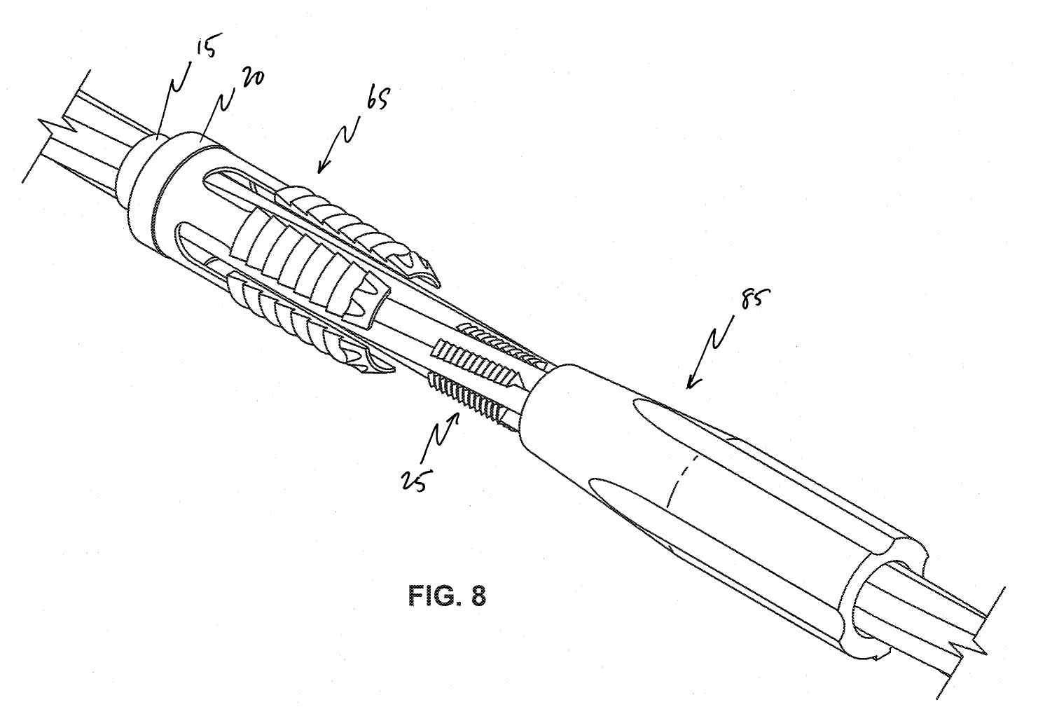

As illustrated in FIG. 8, button 15, or alternatively a birdcage not shown, is secured to cable 1 to form a stop. Retaining piece 20 is disposed about cable 1 proximate button 15. With leaf type member 65 also disposed about cable 1 adjacent retaining piece 20, expansion wedge 85 is disposed about cable 1 with tapered portion 105 adjacent member 65. The inner threads of wedge 65 are compatible with the threaded portion 45 of cable thread insert 25. Wedge 85 engages the threaded portion 45 sufficient to begin threaded engagement between wedge 85 and cable thread insert 25 without causing material expansion of the shell expansion assembly. This comprises the tensionable cable bolt system.

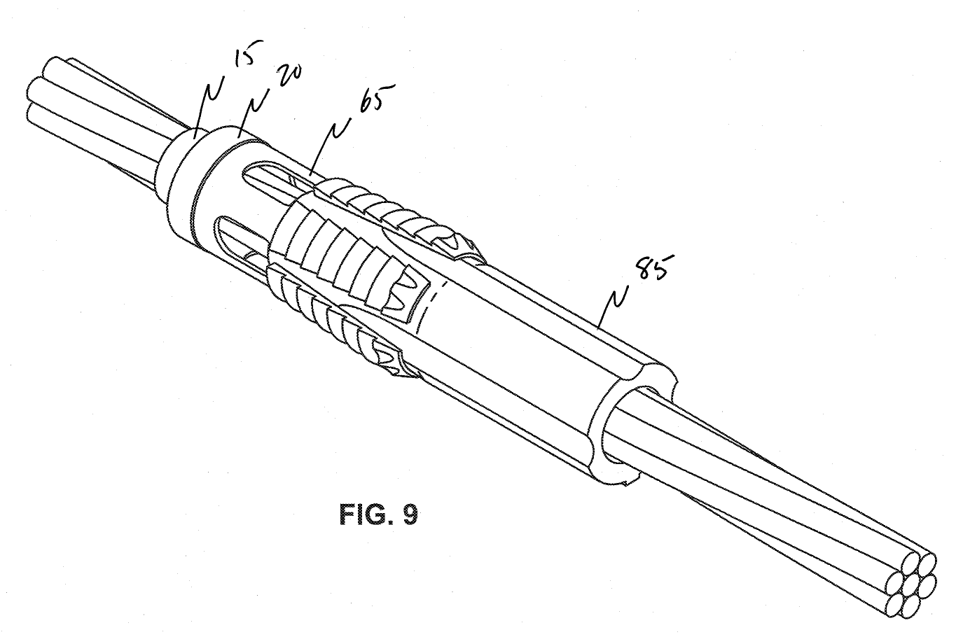

In a mining application, a hole typically 1⅜″ in diameter is drilled into the rock. The tensionable cable bolt system is inserted into the hole to the desired depth. Cable 1 is spun at a desired speed for a desired number of revolutions determined by the user, both of which can be controlled by the time of insertion or by the number of threads or the relative nature and/or length of the threads provided. The spinning action causes the threaded portion 45 of cable thread insert 25 to engage the inner threads of wedge 85 thereby drawing wedge 85 toward retaining piece 20. Wedge 85 and leaf member 65 are held in relative position each other by fin 90 in space 77 between leaves 75. As wedge 85 moves toward retaining piece 20, the exterior surface of wedge 85 engages the inside surfaces of leaves 75. As wedge 85 continues to be drawn toward retaining piece 20, the exterior surface of wedge 85 expands leaves 75 radially outward. As leaves 75 expands radially outward, ridges 80 are implanted in the sidewalls of the drill hole anchoring the tensionable cable bolt system in the rock. FIG. 9 illustrates the expanded state of the tensionable cable bolt system.

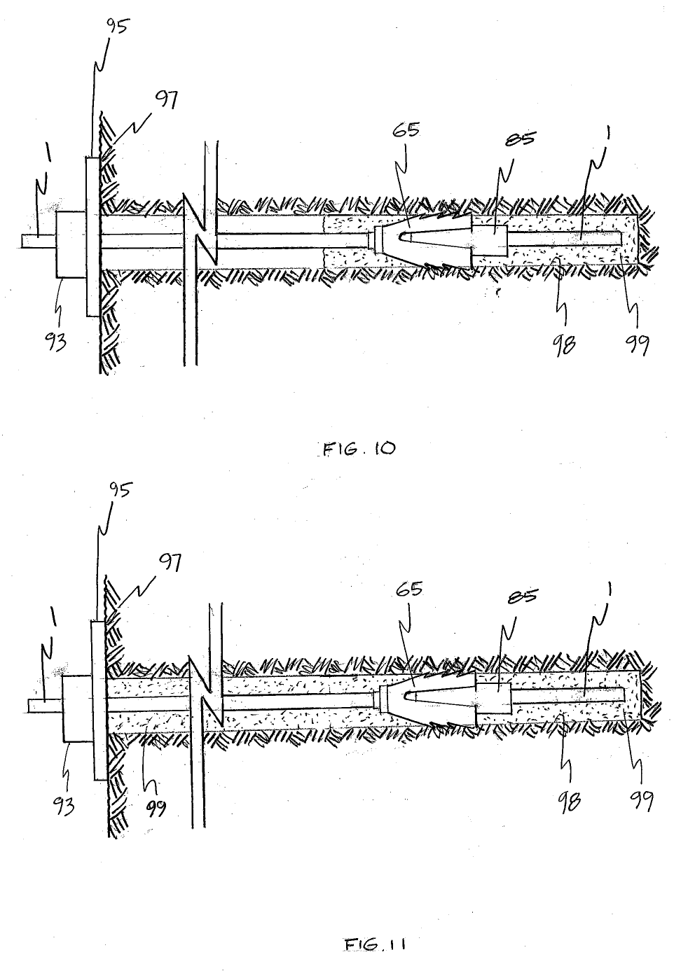

Another mining application is illustrated in FIGS. 10 and 11. After drilling the hole, the hole is first filled with separated resin components along the desired length(s) of the hole. The tensionable cable bolt system is forced into the hole to a desired depth and spun. Grooves 100 on wedge 85 permit passage of resin past wedge 85. The forcing of the tensionable cable bolt system into the hole and spinning of the system causes the separated resin components to be mixed for setting. Again, Cable 1 is spun at a desired speed for a desired number of revolutions. The spinning action causes the threaded portion 45 of cable thread insert 25 to engage the inner threads of wedge 85 thereby drawing wedge 85 toward retaining piece 20. Wedge 85 and leaf member 65 are held in relative position each other by fin 90 in space 77 between leaves 75. As wedge 85 moves toward retaining piece 20, the exterior surface of wedge 85 engages the inside surfaces of leaves 75. As wedge 85 continues to be drawn toward retaining piece 20, the exterior surface of wedge 85 expands leaves 75 radially outward. As leaves 75 expands radially outward, ridges 80 are implanted in the sidewalls 98 of the drill hole anchoring the tensionable cable bolt system in the rock. A head 93 is affixed to cable 1 and is adjacent a bearing plate 95 against the rock 97. As known in the art, head 93 can be rotated to spin the cable and system. If only short-term use of the cable bolt is needed and/or if there is a little concern about corrosion protection, then a portion of the length of the cable and tensionable cable bolt system can be surrounded by resin 99 for partial encapsulation as shown in FIG. 10. If long-term use of the cable bolt is needed and/or if there is a need for corrosion protection, the entire length of the cable and tensionable cable bolt system can be surrounded by resin 99 or full encapsulation as shown in FIG. 11.

Depending on the amount of radial expansion desired, the length of a leaf type member can varied as well as the number of leaves. Similarly, the taper of length 105 of wedge 85 can be varied to effect the desired expansion of the tensionable cable bolt system.

Using tools commonly known in the art, cable 1 can continue to be turned to place the cable under the desired tension or load. Whether the tensionable cable bolt system is used in a hole drilled in rock in a mine or elsewhere, or whether the tensionable cable bolt system is utilized in a desired hole or opening during construction of some building, bridge or road, the present invention provides a new and unique mechanism to modify a cable to receive a desired bolt or fastening system. In this way, cables can be anchored and placed under tension in a way heretofore not available.

It will be appreciated by those skilled in the art that fast or slow setting resins can be used to achieve the desired additional cementing in resin. Use of resins along desired lengths of the drill hole can provide the steel cable and tensionable cable bolt system with the known, additional advantage of corrosion protection by providing a barrier against moisture. Additionally the resin may improve the anchoring of the tensionable cable bolt system with the walls of the hole.

Although specific embodiments and applications of the invention have been described in this specification, there is no intention that the invention be limited these exemplary embodiments and applications or to the manner in which the exemplary embodiments and applications operate or are described herein.

I claim:

1. A cable thread insert apparatus comprising:
a member comprising a length and a channel through the member sized to receive the center wire of a multiwire cable;
a plurality of flanges of the member extending substantially radially outward relative to the hollow channel and defining a plurality of grooves to receive outer wires of the multiwire cable; and
a threaded outer surface on one or more of the flanges, the threaded surface extending beyond the perimeter of the cable.

2. The apparatus of claim 1 wherein the multiwire cable comprises a center wire with six other wires wound around the center wire.

3. The apparatus of claim 1 wherein the hollow channel is through the center of cable thread insert.

4. The apparatus of claim 1 wherein the flanges are helical.

5. The apparatus of claim 1 wherein cable thread insert is integrated into a cable.

6. The apparatus of claim 1 wherein the grooves between the flanges are helical around the hollow channel.

7. A threaded cable system comprising:
a length of multiwire cable having a center wire and a plurality of strands wound around the center wire;
a member comprising a length and a channel through the member sized to receive the center wire of the multiwire cable;
a plurality of flanges of the member extending substantially radially outward relative to the hollow channel and defining a plurality of grooves to receive outer wires of the multiwire cable;
a threaded outer surface on one or more of the flanges, the threaded surface extending beyond the perimeter of the cable
the center wire of the multiwire cable disposed in the hollow channel; and
a plurality of the outer strands of the multiwire cable disposed in grooves between flanges.

8. The system of claim 7 further comprising:
a bolt comprising inner threads corresponding to the threaded outer surface on the flanges.

9. The system of claim 7 further comprising:
an expansion shell assembly with threads corresponding to the threaded outer surface on the flanges.

10. The system of claim 9 wherein the expansion shell assembly comprises a leaf type expandable shell and a wedge, the wedge have inner threads and which wedge is drawn into the expandable shell by the threaded outer surface on the flanges.
